(19) United States
(12) Patent Application Publication
(10) Pub. No.: US 2009/0006027 A1
(43) Pub. Date: Jan. 1, 2009

(54) Automatic Mattress Selection System

(75) Inventor: W. Eric Hinshaw, Mebane, NC (US)

Correspondence Address: SHOEMAKER AND MATTARE, LTD, 10 POST OFFICE ROAD - SUITE 110, SILVER SPRING, MD, 20910, US

(73) Assignee: KINGSDOWN, INCORPORATED, Mebane, NC (US)

(21) Appl. No.: 12/092,903

(22) PCT Filed: Nov. 7, 2005
(86) PCT No.: PCT/US05/40211

§ 371 Date: Sep. 10, 2008

(51) Int. Cl. G06F 15/00

(52) U.S. Cl. 702/129; 702/139; 702/173

(57) ABSTRACT

A couple shopping for a mattress are helped to select a physiologically suitable mattress by a system which uses a questionnaire to elicit important information from the people. The questionnaire data is processed automatically, preferably in combination with physically measured data, to generate a recommendation of which available mattress system is most suitable for both people, or, if no mattress system is suitable for both people, then a recommendation for separate mattress systems which can conjoined or used together.

### BACKGROUND OF THE INVENTION

This invention relates to a system for aiding bedding purchasers in their selection of a mattress and box spring combination according to their physiology and habits.

A good night's sleep is so important that most people are willing to pay a premium for a mattress system which is particularly comfortable. The increased recognition of the health benefits of sleeping well makes such expenditures rational.

Many people find the experience of purchasing bedding confusing and dissatisfying. Reasons for this include: (1) mattress purchases are made only a few times per lifetime, (2) one cannot examine the interior of the product being purchased and must therefore (3) rely on the expertise of commissioned salesmen who may tend to recommend products they have in stock, and (4) it is difficult to comparison price shop because of the very large number of mattress manufacturers and models, and the absence of standardized mattress ratings.

It would be helpful to bedding purchasers to have an automatic system which could analytically and fairly measure physiological parameters important to mattress selection, and then automatically recommend a bedding product most suitable for the purchaser. Such a system, if placed in a store, would give customers an unbiased recommendation.

### SUMMARY OF THE INVENTION

An object of the invention is to enable mattress distributors and the like to measure the sleeping attributes of potential customers at sites convenient to the customers, so that properly designed bedding can be selected.

It is important that a measuring system be fast, accurate and not embarrassing or uncomfortable for the subject. Therefore, it is an object of this invention to provide a measuring system which requires only that the subject answer a few basic questions (height, age gender, etc.), and then lie on a test bed for a few moments, in order to produce a recommended bedding selection.

Another feature of the invention is to enable a purchaser who does not have access to the test bed to obtain a mattress recommendation based entirely on answers to a questionnaire. For example, a person buying a mattress can obtain a recommendation for him or herself by the method described above, and then in addition enter information about the absent partner so that a bedding recommendation for the couple jointly can be obtained. If the people are so different in size or habits that a joint bedding recommendation cannot be made, then separate recommendations are made; these may be followed by purchasing twin beds having different characteristics, and using them together.

The questionnaire-only method may be used by people shopping remotely, e.g., over the internet.

These and other objects are attained by mattress selection system as described below.

### BRIEF DESCRIPTION OF THE DRAWINGS

In the accompanying drawings,

FIG. 1 is an exploded isometric view of a test bed embodying the invention;

FIGS. 2-11 are schematic representations of a method for processing sleep attribute data and developing a bedding recommendation. In particular,

FIG. 2 illustrates the starting sequence of the diagnostic system;

FIG. 3 shows the flow of a questionnaire;

FIG. 4 is a flow diagram illustrating a method of setting up a diagnostic bed;

FIG. 5 shows the steps of obtaining a physiological profile a subject;

FIGS. 6-9 show, in successive linked diagrams, a method for determining a sleep coefficient based on questionnaire data and physiological data; and

FIG. 10 shows a pair of beds, having different characteristics.

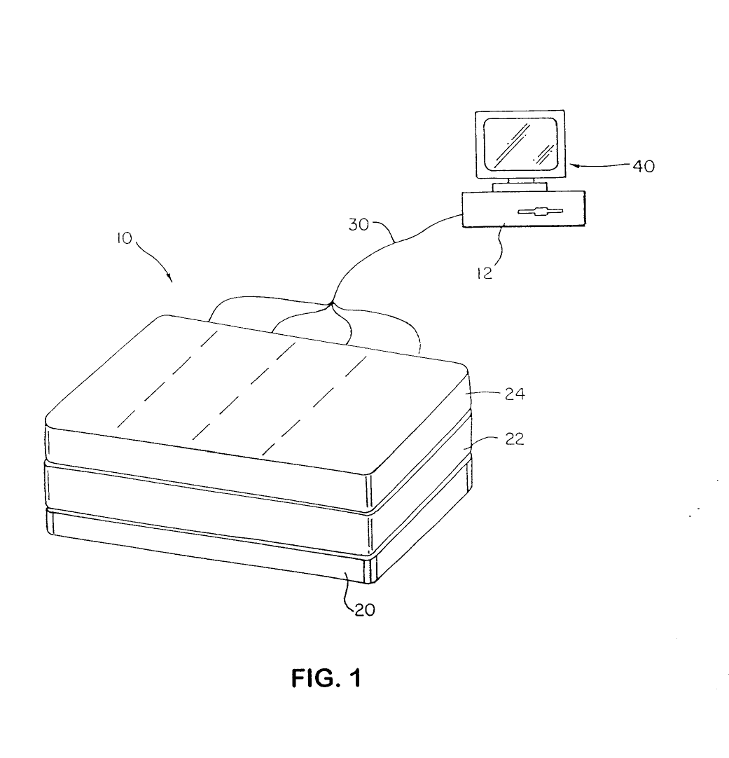

### DESCRIPTION OF THE PREFERRED EMBODIMENT

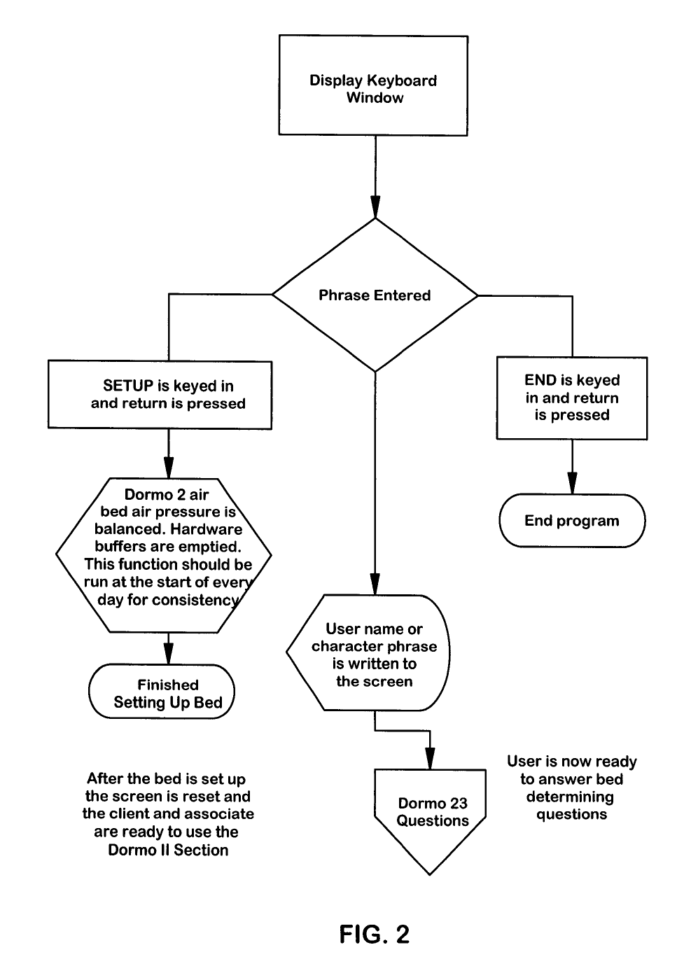

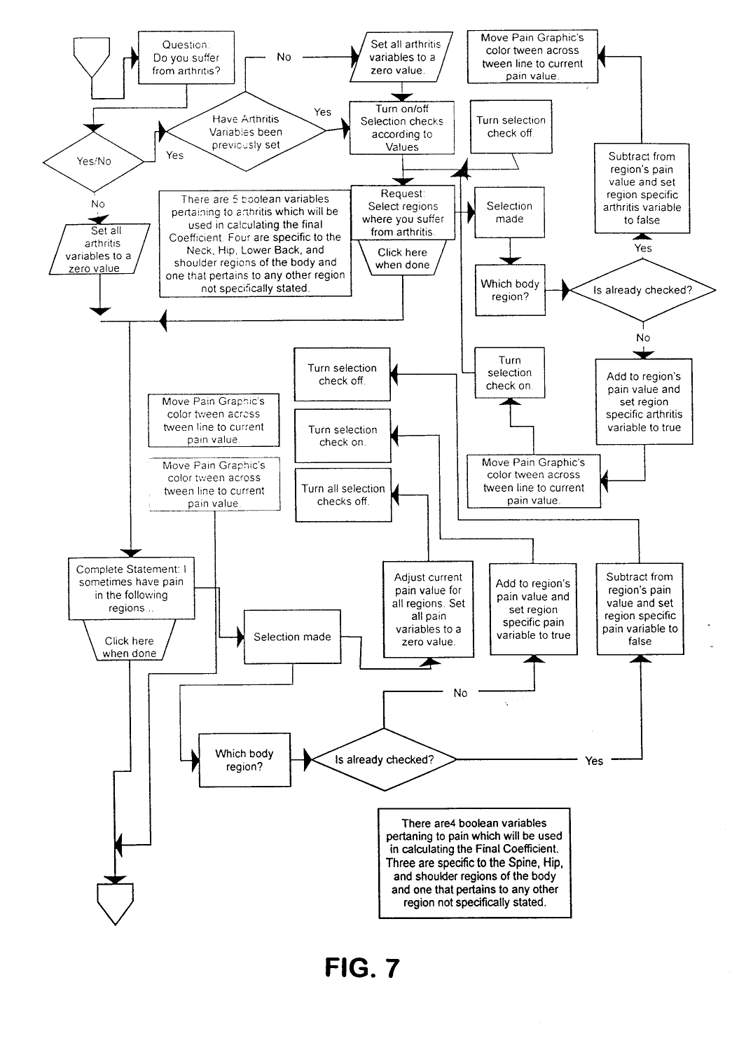

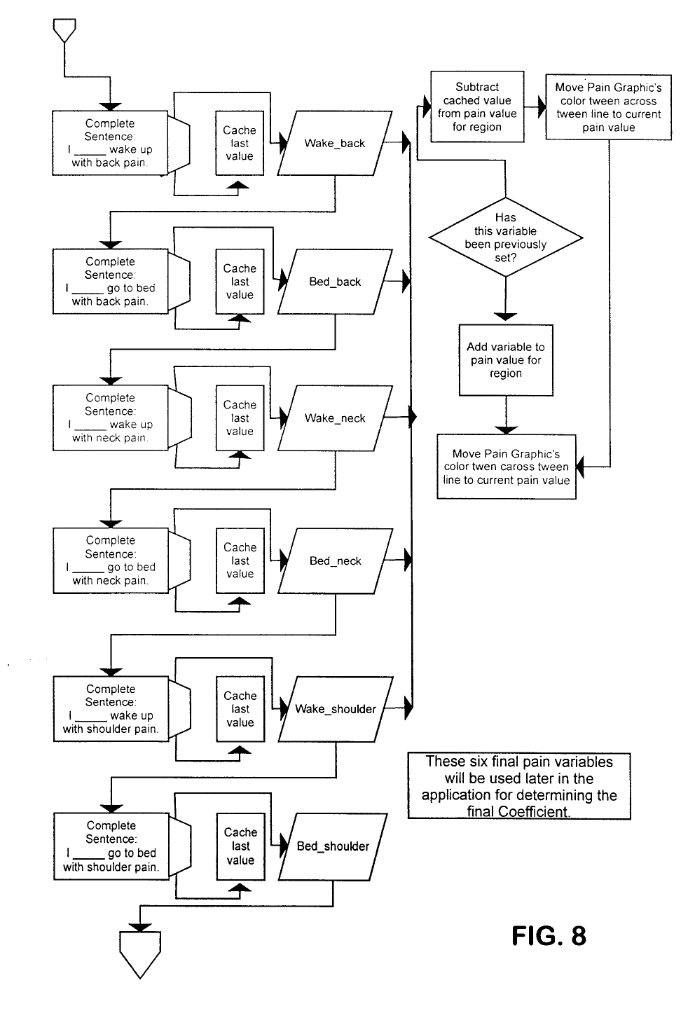

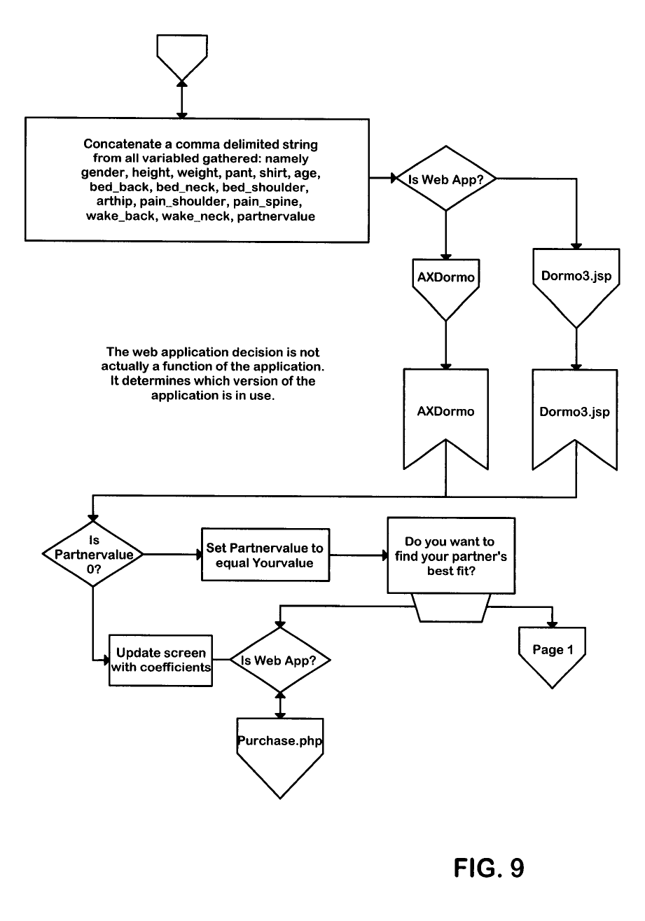

A sleep analysis system for aiding bed selection comprises a measuring apparatus 10 which produces electrical outputs that are processed by a computer 12 which processes the outputs in a manner directed by a program (FIGS. 2-11) to generate an output in the form of a bed coefficient which can be used to select bedding.

The test bed comprises a frame 20 which supports a box spring 22 and a compartmented air mattress 24. The cells of the air mattress are divided into anatomical zones. When a subject lies on the mattress, different pressures are produced at each zone. The pressure readings are converted to electrical signals by appropriate transducers, not shown, and those signals are communicated over a multi-conductor cable 30 as inputs to a central processing unit, for example a personal computer 40. The computer reads the various inputs and processes them, in accordance with instructions from a program (software) which has been loaded on the computer previously, or which perhaps is accessed through a network such as the internet.

While it would be possible to custom-build a mattress system precisely for the subject, from the data collected, it is presently contemplated to provide the store with a small number (e.g., four) of mattress systems spanning a range of characteristics, and to provide a recommendation for one of those, based on the closest fit of the data.

We have found that the data from the pressure-sensor array can be substantially enhanced by eliciting additional information from the subject. A brief questionnaire is used for this purpose. There is an inverse relationship between the amount of questionnaire data needed and the amount of sensor data available. We have found that, in addition to the sensor data, only four questions need be answered: the subject's age, height, gender, and chronic pain state. Where sensor data cannot be obtained, a more lengthy questionnaire is used, the extra questions making up for the absence of measured data.

In the first instance, the questionnaire data is processed in conjunction with the sensor data by a computer program or application (software) which processes the inputs automatically according to a first algorithm contained in the software. Where sensor data is not available, the answers to the longer questionnaire are processed alone, by a second algorithm.

It is useful to have both algorithms available in a store-based system, so that information can be obtained not only from shoppers, but also for absent sleep partners. Suppose, for example, one partner is present in the store. That person can answer the short questionnaire, and be measured on the test bed. Then, by completing the long-form questionnaire for a partner, and having that information processed by the second algorithm, a net recommendation can be generated, based on a calculation of the results of both computations.

The second algorithm is useful independently, as well, for example by people shopping via the internet, who lack access to the test bed and cannot produce sensor-based data. We believe the combination of questionnaire and sensor data produces the best results, but we have found the long-form questionnaire data to produce quite reliable results as well.

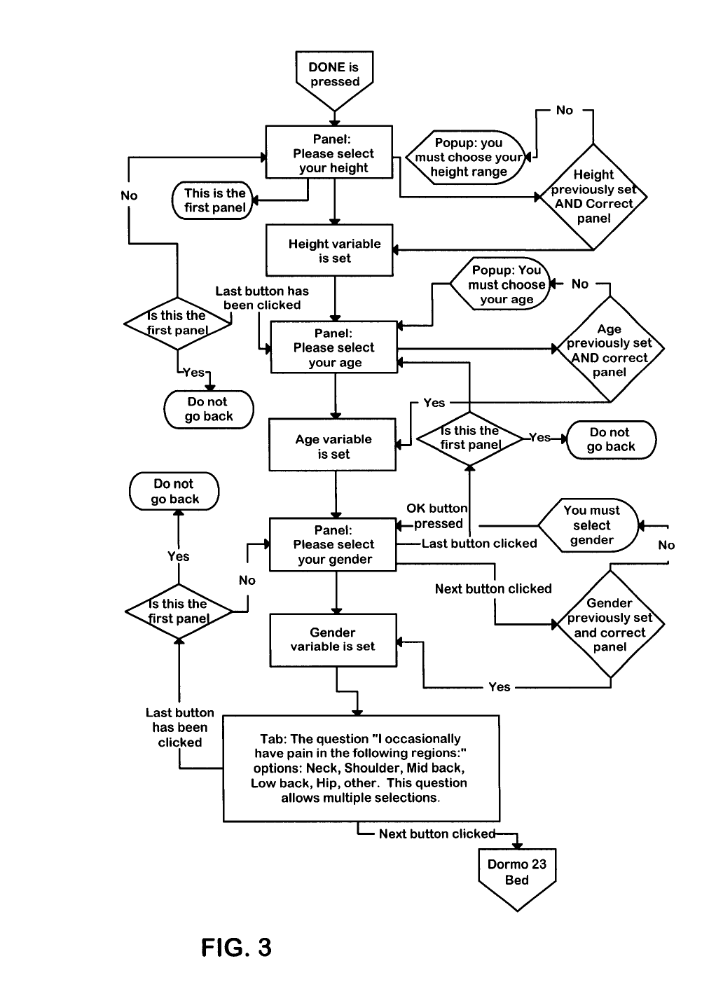

A particularly preferred implementation of the invention is shown in schematic form in FIGS. 2-11. From here on, it will be assumed the display has a touch screen, and that selections are made simply by touching a particular area on the screen. As shown in FIG. 2, a customer who approaches the kiosk sees a multimedia presentation running in a loop. When he touches the display screen, a virtual keyboard appears, and a prompt invites entry of the initials of a sleep consultant (salesman). After the initials are entered, the display prompts the customer to enter his name. If the exact phrase “END” (FIG. 2) is entered, the program is ended. If the exact phrase “SETUP” is entered, the air bed pressure is balanced, and hardware buffers are emptied. These exact phrases are expected to be entered only by store personnel. In FIG. 3, the user is then prompted to enter his height. Following validation of the height data (to be within a predetermined range), the entry is saved to a variable. Next, the user is prompted to enter his age (select one of a number of displayed ranges), which is similarly validated and saved to a variable. The customer may be prompted by a video prompt or, more preferably, a voice prompt. A gender entry is similarly saved to a variable. Lastly, the user is asked whether he has occasional pain in the neck, shoulder, middle back, lower back, or other areas, and selects one or more items from that list, the selections being saved to variables.

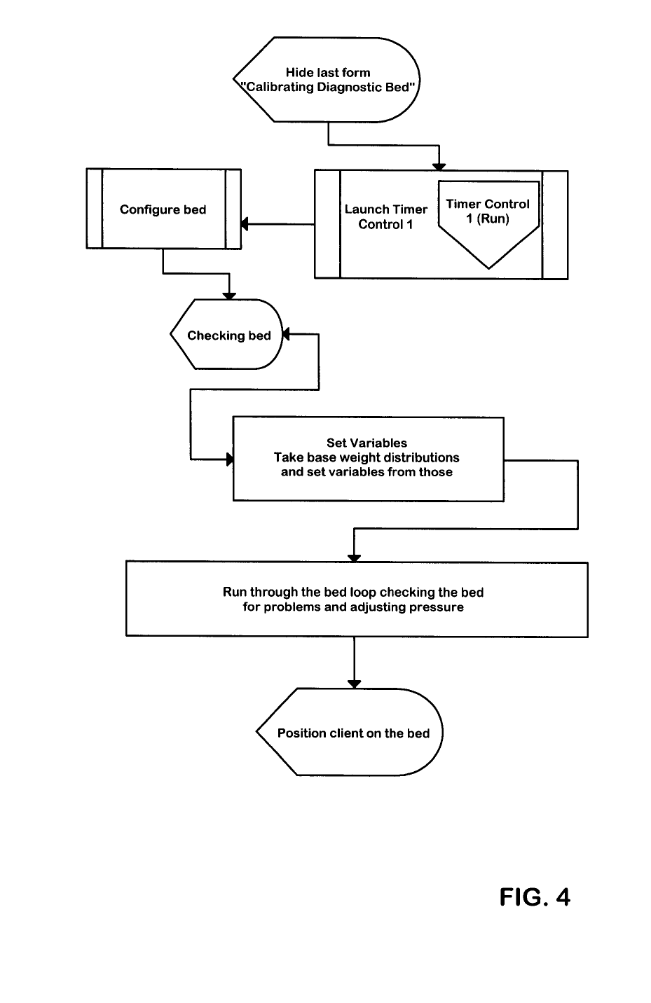

Before the subject lies on the test bed, it must be set up by a program (FIG. 4) which inflates the pressure cells, checks for errors in the bed, and resets variables from base weight distributions.

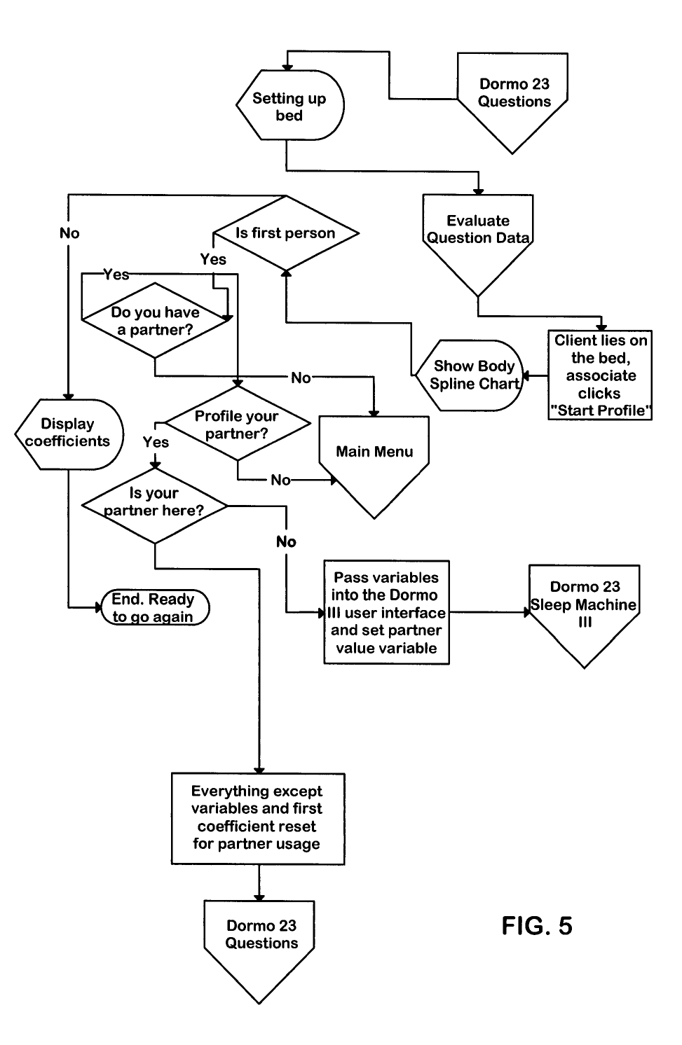

After the bed has been set up, the user is instructed to lie supine (face up) on the bed. An associate strikes a “Start Profile” button on the screen (FIG. 5). As the person lies on the bed, the pneumatic pressure in the four zones of the air mattress are monitored. After a brief time, sufficiently long to achieve steady-state readings, the program samples the pressure signals, and combines them with the results of the questionnaire, to generate a “coefficient” representing the bedding (mattress and box spring combination) choice most appropriate for the subject. This coefficient is displayed prominently on the screen, and stored in memory.

Next, if the subject was the first person during the session to lie on the bed, he is asked (FIG. 5) whether he has a sleep partner. If there is an affirmative reply, and the second person is present, the second person is invited to respond to the short form questionnaire, following which he is instructed to lie on the bed, and the process described above is repeated. The second person's values are compared with those of the first person. If the values result in individual bedding recommendations which are within a predetermined number of grades, a bed coefficient is determined which represents the best compromise choice for the two people. If the values are outside the predetermined grade range, then separate bedding recommendations are made for each person. For example, the user may be displayed a message like “Blending is not recommended”, and separate sleep surfaces that can be joined or used in tandem is recommended in that case.

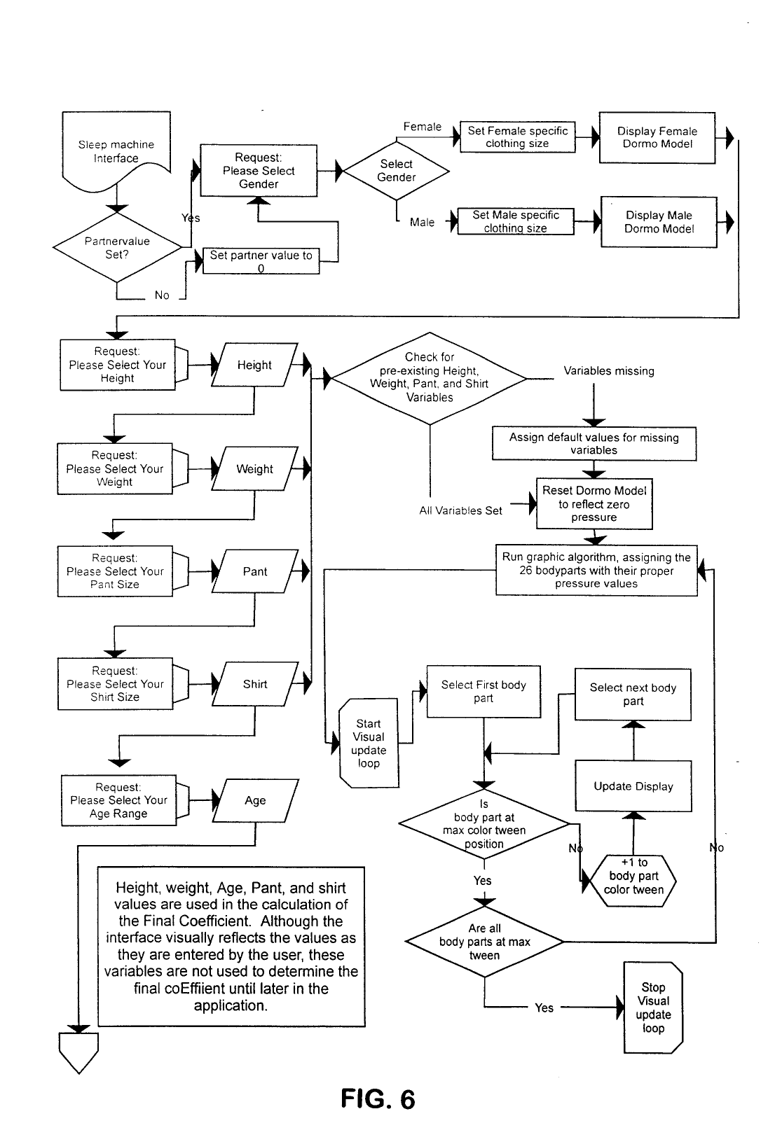

If the subject answers that his partner is not present, he is offered an opportunity to answer the long-form questionnaire, represented in FIGS. 6-9, on behalf of the second person. Here, the questions are more numerous, but nevertheless should be answerable by an intimate partner: gender, height, weight, clothing sizes, age range and so on. All questions must be answered. As the answers are processed, the body image on the screen is altered to fit the answers to the questionnaire, as if the person were lying on the test bed.

A subsequent set of questions involve arthritic pain: multiple locations of such pain may be selected, and a graphic pain representation is added to the image. The next set of questions related to pain: whether the missing person goes to bed with, or wakes up with, neck, shoulder, back, hip, or “other” pain. Answers are stored to variables, and the image representing the person is altered to illustrate the pain as appropriate.

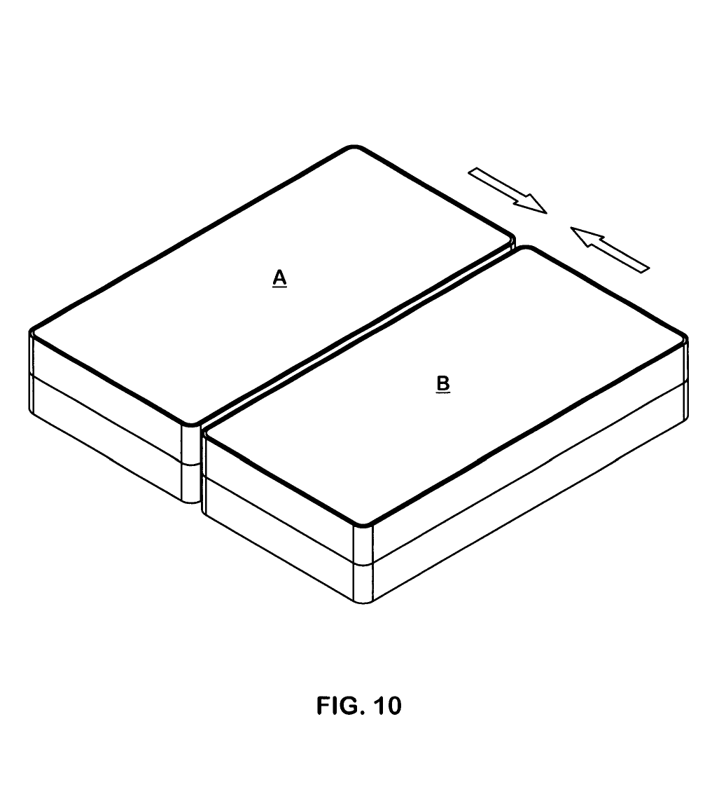

The answers to the long-form questionnaire are processed and a best-fit bed coefficient for the missing partner is produced. If the bed coefficients for the couple are within a predetermined range, the coefficients are processed to produce a compromise best fit for the couple. If the bed coefficients are outside the predetermined range, separate bedding is recommended, for example conjoinable twin beds A and B (FIG. 10). In either event, the sales associate can show the couple selected bed(s) matching the correct bed coefficient(s), and the couple will have greater assurance their selection will be a correct one.

Since the invention is subject to modifications and variations, it is intended that the foregoing description and the accompanying drawings shall be interpreted as only illustrative of the invention defined by the following claims.

1. A system for recommending bedding for two people, said system comprising
a questionnaire for securing objective answers to questions about each person's physiological parameters, and
means for automatically processing said answers to produce a bedding coefficient for each person, representing which of a plurality of different mattress systems is most suitable for that person,
means for determining whether the bedding coefficients for the two people are within a predetermined range and, if they are within said range, processing said coefficients to produce a recommendation for a single bed and, if they are not within said range, using said coefficients to produce recommendations for individual beds.

2. The system of claim 1, wherein said questionnaire elicits each person's age, height and gender.

3. The system of claim 2, wherein the questionnaire asks for each person's clothing sizes.

4. The system of claim 2, wherein the questionnaire asks whether the person has chronic or arthritic pain, and if so, where such pains are located.

5. The system of claim 1, further comprising means for measuring a first set of physical parameters of at least one person and means for combining data thus obtained with said questionnaire answers.

6. A method for recommending bedding for two people, said method comprising steps of
securing objective answers to a questionnaire comprising questions about each person's physiological parameters,
automatically processing said answers to produce a bedding coefficient for each person, representing which of a plurality of different mattress systems is most suitable for that person,
determining whether the bedding coefficients for the two people are within a predetermined range and, if they are within said range, processing said coefficients to produce a recommendation for a single bed and, if they are not within said range, using said coefficients to produce recommendations for individual beds.

7. The method of claim 6, wherein said questionnaire elicits each person's age, height and gender.

8. The method of claim 7, wherein the questionnaire asks for each person's clothing sizes.

9. The method of claim 7, wherein the questionnaire asks whether the person has chronic or arthritic pain, and if so, where such pains are located.

10. The method of claim 6, further comprising steps of
measuring a first set of physical parameters of at least one person and
combining data thus obtained with said questionnaire answers.

11. A system for recommending bedding for two people, said system comprising
a questionnaire for securing objective answers about each person's gender, age range, height range and chronic pains,
means for measuring each person's physiological parameters,
said means comprising an air mattress divided into anatomical zones and means for gathering data from the zones when a person reclines on the mattress,
means for combining the answers from the questionnaire and the data from the air mattress to produce a bedding coefficient for each person,
means for representing which of a plurality of different mattresses is most suitable for that person, and
means for determining whether the bedding coefficients for the two people are within a predetermined range and, if they are within range, processing the coefficients to produce a recommendation for a single bed and, if they are not within range, using the coefficients to produce recommendations for individual beds.

12. A method for recommending bedding for two people, said method comprising steps of
securing objective answers to a questionnaire comprising questions about each person's physiological parameters,
measuring each person's physiological parameters by causing each person to lie on an air mattress divided into anatomical zones and gathering data from the zones when a person reclines on the mattress,
combining the answers from the questionnaire and the physiological data from the air mattress to produce a bedding coefficient for each person,
automatically processing said answers to produce a bedding coefficient for each person, representing which of a plurality of different mattress systems is most suitable for that person, and
determining whether the bedding coefficients for the two people are within a predetermined range and, if they are within said range, processing said coefficients to produce a recommendation for a single bed and, if they are not within said range, using said coefficients to produce recommendations for individual beds.
